(19) United States
(12) Patent Application Publication
(10) Pub. No.: US 2025/0107509 A1
(43) Pub. Date: Apr. 3, 2025

(54) Livestock Weighing and Isolation System

(71) Applicant: 701x Inc., Fargo, ND (US)

(72) Inventors: Kevin N. Biffert, Horace, ND (US); Maximillion K. Cossette, Fargo, ND (US); Steven J. Berlinger, Dilworth, MN (US); Peter S. Crowley, Fargo, ND (US); Cole L. Mehring, Fargo, ND (US); Keith D. Alsleben, Fargo, ND (US); Braydon W. Love, Fergus Falls, MN (US); Chad A. Heath, Fargo, ND (US)

(21) Appl. No.: 18/479,503

(22) Filed: Oct. 2, 2023

(51) Int. Cl. A01K 29/00; A01K 1/00

(52) U.S. Cl. CPC A01K 29/005; A01K 1/0017; A01K 11/006

(57) ABSTRACT

Livestock weighing and isolation systems are disclosed herein. An example system includes an enclosure having a temporary confinement area and a scale for weighing an animal, an identification reader for detecting a unique identification tag associated with the animal, a database for storing information associated with the animal, including a weight of the animal and time of weighing, and a service provider configured to update information associated with the animal in the database upon receiving the weight from the scale and the identification from the identification reader.

### CROSS-REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

The described example embodiments in general relate to a livestock weighing and isolation system, and more particularly, but not by way of limitation, to systems and methods that can be used to isolate an animal and perform one or more actions such as weighing, medicating, health scanning, and/or other related actions.

### SUMMARY

A system for livestock management integrates several components. The system includes a scale that weighs the animals as they pass, and an identification reader that detects a unique identification tag associated with each animal. This tag could be any type of short or long-range sensor. Data is stored in a database that maintains comprehensive records for each animal, including weight and the time of weighing. A processor is incorporated within the system, which is programmed to update the animal's record in the database every time a weight reading is taken and the animal's tag is identified. This automation ensures frequent and accurate data collection, thereby enhancing overall livestock management.

A method for automatically managing livestock includes detecting a unique identification tag associated with an animal. The animal is then weighed on a scale, and this information, along with the time of weighing, is stored in a database associated with the animal. The method involves updating the database based on the detected unique identification tag and the weight, thereby providing an accurate and up-to-date record for each animal. This method of livestock management promotes efficient monitoring and proactive care, contributing to enhanced animal health and productivity.

There have thus been outlined, rather broadly, some of the embodiments of the present disclosure in order that the detailed description thereof may be better understood, and in order that the present contribution to the art may be better appreciated. There are additional embodiments that will be described hereinafter and that will form the subject matter of the claims appended hereto. In this respect, before explaining at least one embodiment in detail, it is to be understood that the various embodiments are not limited in their application to the details of construction or to the arrangements of the components set forth in the following description or illustrated in the drawings. Also, it is to be understood that the phraseology and terminology employed herein are for the purpose of the description and should not be regarded as limiting.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evidence to the contrary from the description, where elements in different figures use identical reference numbers, the elements are generally either identical or at least similar in function or purpose.

### BRIEF DESCRIPTION OF THE DRAWINGS

FIG. 1 is a perspective view of an example architecture in accordance with an example embodiment.

FIG. 2 is a schematic diagram of an example system of the present disclosure.

FIG. 3 is a schematic diagram of another example system of the present disclosure.

FIG. 4 is a flowchart of an example method of the present disclosure.

FIG. 5 is a flowchart of an example method of the present disclosure.

### DETAILED DESCRIPTION

### A. Overview

U.S. Patent Publication No. US-2022-0192152-A1, the entire disclosure of which, except for any definitions, disclaimers, disavowals, and inconsistencies, is incorporated herein by reference.

Disclosed herein are systems and methods that provide an approach to managing the health and well-being of animals. One example aspect of the system includes an alleyway equipped with a scale for precise weight measurements. As an animal walks along the alleyway, the scale can obtain a weight and a reader identifies a unique tag associated with the animal. This tag, which could be any type of sensor (short or long-range wireless), is associated with a record in a database, allowing the system to automatically update the animal's weight and the date and time of weighing in the record.

An example system is designed to encourage regular use, with the addition of an attractant such as feed, water, or minerals placed beyond the scale to entice the animals. This configuration allows for frequent and accurate weight checks throughout the season, eliminating inaccuracies and gaps in data collection.

One feature of an example system is its capacity to respond immediately to individual animals' needs. If the system recognizes an animal that requires special attention—due to health concerns, estrus cycle, or the need for removal from the pasture—the system can activate gates in the enclosure to isolate the animal. This allows the rancher to easily load the animal into a trailer or bring a portable chute to perform necessary work. An enclosure can have at least one gate, but in some embodiments, the enclosure can have an ingress and egress gate. In another embodiment, a gate can be included that can be used in instances where the animal needs to be removed from the herd via a truck or trailer. This gate can be configured for that purpose.

Another potential embodiment could include the capacity to transfer weight data directly from the scale to the animal's tag. This data would then be uploaded whenever the tag connects to the system (e.g., in communications range with a network device), ensuring even more accurate record keeping. Similarly, a base station associated with the enclosure could cause an automatic action based on the tag detected, such as trapping the animal in a specific area equipped with food, water, or minerals.

Additional features could include an automatic chemical applicator, which could administer necessary treatments like spray-on repellants as the animal passes. The system could also automatically apply necessary medical treatments, like vaccines or boosters, based on the animal's medical history stored in the database.

An example livestock management system could be further enhanced with the inclusion of a directional antenna connected (electrically and/or communicatively) with a base station, which would allow an example system to record data associated only with the animal in a specific location, such as a chute, an alleyway, or another area of confinement. A directional focus, such as this, could improve the accuracy of data recording, contributing to a more comprehensive understanding of each animal's health and well-being. To be sure, these systems and methods offer a proactive approach to livestock management, integrating automatic data collection and treatment application for efficient and effective animal care.

### B. Exemplary Telecommunications Networks

Some of the embodiments of the present disclosure may be utilized upon any telecommunications network capable of transmitting data including voice data and other types of electronic data. Examples of suitable telecommunications networks for some of the embodiments of the present disclosure include but are not limited to global computer networks (e.g., Internet), wireless networks, cellular networks, satellite communications networks, cable communication networks (via a cable modem), microwave communications network, local area networks (LAN), wide area networks (WAN), campus area networks (CAN), metropolitan-area networks (MAN), and home area networks (HAN). Some of the example embodiments of the present disclosure may communicate via a single telecommunications network or multiple telecommunications networks concurrently. Various protocols may be utilized by electronic devices for communications such as but not limited to HTTP, SMTP, FTP and WAP (wireless Application Protocol). Some of the embodiments of the present disclosure may be implemented upon various wireless networks such as but not limited to 3G, 4G, 5G, LTE, CDPD, CDMA, GSM, PDC, PHS, TDMA, FLEX, REFLEX, IDEN, TETRA, DECT, DATATAC, and MOBITEX. Some of the various example embodiments of the present disclosure may also be utilized with online services and internet service providers.

The Internet is an exemplary telecommunications network for the embodiments of the present disclosure. The Internet is comprised of a global computer network having a plurality of computer systems around the world that are in communication with one another. Via the Internet, the computer systems are able to transmit various types of data between one another. The communications between the computer systems may be accomplished via various methods such as but not limited to wireless, Ethernet, cable, direct connection, telephone lines, and satellite.

### C. Central Communication Unit

The central communication unit may be comprised of any central communication site where communications are preferably established with. The central communication units may be comprised of a server computer, cloud-based computer, virtual computer, home computer or other computer system capable of receiving and transmitting data via IP networks and the telecommunication networks. As can be appreciated, a modem or other communication device may be required between each of the central communication units and the corresponding telecommunication networks. The central communication unit May be comprised of any electronic system capable of receiving and transmitting information (e.g., voice data, computer data, etc.).

### D. Mobile Device

The mobile device may be comprised of any type of computer for practicing the various aspects of the embodiments of the present disclosure. For example, the mobile device can be a personal computer (e.g., APPLE® based computer, an IBM based computer, or compatible thereof) or tablet computer (e.g., IPAD®). The mobile device may also be comprised of various other electronic devices capable of sending and receiving electronic data including but not limited to smartphones, mobile phones, telephones, personal digital assistants (PDAs), mobile electronic devices, handheld wireless devices, two-way radios, smart phones, communicators, video viewing units, television units, television receivers, cable television receivers, pagers, communication devices, and digital satellite receiver units.

The mobile device may be comprised of any conventional computer. A conventional computer preferably includes a display screen (or monitor), a printer, a hard disk drive, a network interface, and a keyboard. A conventional computer also includes a microprocessor, a memory bus, random access memory (RAM), read only memory (ROM), a peripheral bus, and a keyboard service provider. The microprocessor is a general-purpose digital processor that controls the operation of the computer. The microprocessor can be a single-chip processor or implemented with multiple components. Using instructions retrieved from memory, the microprocessor controls the reception and manipulations of input data and the output and display of data on output devices. The memory bus is utilized by the microprocessor to access the RAM and the ROM. RAM is used by microprocessor as a general storage area and as scratch-pad memory, and can also be used to store input data and processed data. ROM can be used to store instructions or program code followed by microprocessor as well as other data. A peripheral bus is used to access the input, output and storage devices used by the computer. In the described embodiments, these devices include a display screen, a printer device, a hard disk drive, and a network interface. A keyboard service provider is used to receive input from the keyboard and send decoded symbols for each pressed key to microprocessor over bus. The keyboard is used by a user to input commands and other instructions to the computer system. Other types of user input devices can also be used in conjunction with the embodiments of the present disclosure. For example, pointing devices such as a computer mouse, a track ball, a stylus, or a tablet to manipulate a pointer on a screen of the computer system. The display screen is an output device that displays images of data provided by the microprocessor via the peripheral bus or provided by other components in the computer. The printer device when operating as a printer provides an image on a sheet of paper or a similar surface. The hard disk drive can be utilized to store various types of data. The microprocessor, together with an operating system, operates to execute computer code and produce and use data. The computer code and data may reside on RAM, ROM, or hard disk drive. The computer code and data can also reside on a removable program medium and loaded or installed onto computer system when needed. Removable program mediums include, for example, CD-ROM, PC-CARD, USB drives, floppy disk and magnetic tape. The network interface circuit is utilized to send and receive data over a network connected to other computer systems. An interface card or similar device and appropriate software implemented by microprocessor can be utilized to connect the computer system to an existing network and transfer data according to standard protocols.

### E. Example Embodiments

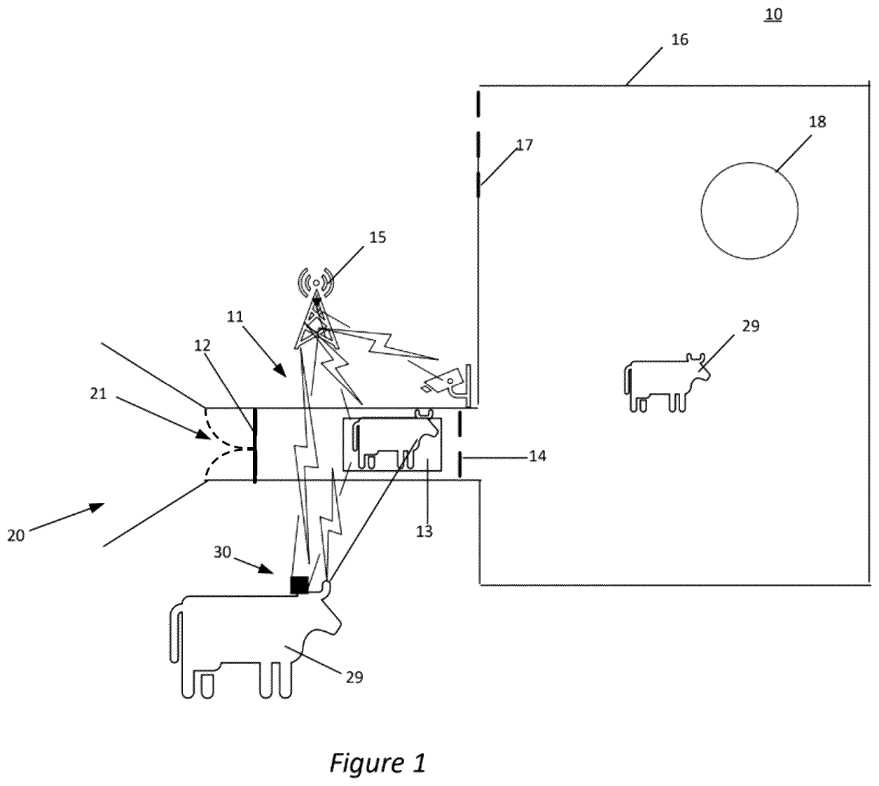

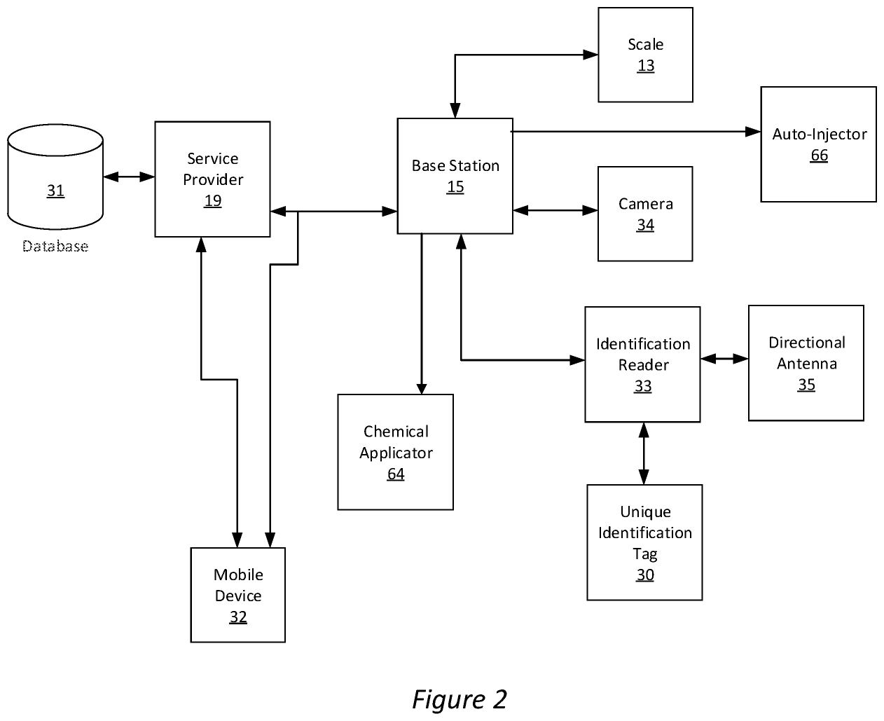

Referring now to FIGS. 1 and 2 collectively, which illustrates an architecture or system of the present disclosure. The system 10 includes a temporary confinement area 11, a first gate 12, a scale 13, a second gate 14, a base station 15, an enclosure 16, a third gate 17, an attractant 18, and a service provider 19.

In some embodiments, the temporary confinement area 11 can include a funnel portion 20 that is created from fencing or railing. The temporary confinement area 11 will be understood to include any suitable confinement space such as squeeze chute, a head chute, an alleyway, or any similar structure. In fact, the term “chute” can include any confined space where an animal can be retained for a portion of time. The chute can be positioned before, within, or and an exit of a larger enclosure. The chute could be defined by gates, fencing, or any other structure, and is thus understood to be broadly encompassing of an area of confinement that is intended to keep an animal confined temporarily before being discharged to a pasture, paddock, or other enclosure.

The funnel portion 20 has a widest aspect that is approximately eight to twelve feet in width (any size can be chosen) that narrows into a neck portion 21 that is approximately 26 to 28 inches in width, which is wide enough to accommodate a single animal 29. The animal 29 can include any domesticated type of livestock.

Each animal can be associated with a unique identification tag 30 that can include any short-or-long range wireless protocol sensor. The unique identification tag 30 can be configured to capture data pertaining to the animal that can be used to assess movement, health, feeding, and/or any number of metrics. The unique identification tag 30 can be implanted, attached to an ear tag, or attached to a collar-just to name a few. In general, the unique identification tag 30 can both receive and store information, as well as transmit that information when connected to a network. The unique identification tag 30 can also communicate directly with another electronic device, such as a mobile device, a different unique identification tag 30, scanner, base station, or other types of infrastructure. To be sure, the unique identification tag 30 can store a unique identifier for the animal 29. In another example, the hardware of the unique identification tag 30 has a unique identifier that is tracked and associated with a particular animal.

When the animal 29 is directed into the temporary confinement area 11, the animal 29 will encounter the first gate 12. The first gate 12 can be manually or automatically actuated to open and allow the animal 29 to enter and proceed toward the scale 13. This actuation can be caused by the service provider 19 or the base station 15. The first gate can be manually or automatically closed once the animal 29 is inside the scale area. The second gate 14 remains closed to prevent the animal 29 from leaving the scale area. However, in some embodiments, both the first gate 12 and the second gate 14 remain open prior to an animal 29 entering the temporary confinement area. Some animals prefer to see openings and light rather than closed gates, making them more willing to enter the temporary confinement area 11 for the attractant 18. When the animal 29 steps on the scale 13, both the first gate 12 and second gate 14 automatically close to contain the animal 29 in the temporary confinement area 11.

In some embodiments, when the animal 29 steps on the scale 13, the first gate 12 is closed. Again, the detection of the animal 29 stepping on the scale 13 can be mediated by the base station 15 when it receives a signal from the scale 13 that indicates that an animal 29 has stepped on the scale 13. The base station 15 can maintain logic that prevents erroneous gate closings that would occur due to a person or other smaller object stepping on the scale 13. Thus, the base station 15 may compare the weight reading to a threshold value before closing the first gate 12.

When the animal 29 is cordoned off between the first gate 12 and the second gate 14, the unique identification tag 30 on the animal 29 connects wirelessly to the base station and exchanges information with the base station 15. For example, the tag 30 can transmit information to the base station 15 that uniquely identifies the animal 29, as noted above. The unique identification tag 30 can offload any other collected information to the base station 15. The base station 15 can include an identification reader 33 that is configured to communicate with the unique identification tag 30. This identification reader could scan the unique identification tag 30 and obtain information. The identification could be embodied as a directional antenna, a camera, a scanner of any type, or combinations thereof. The base station 15 could also include a camera 34 that is used to visually inspect the animal 29 to look for signs of health or distress.

The scale 13 can obtain a weight for the animal 29 and transmit the same to the base station 15 over a wired or wireless connection. Additionally, a time stamp can be added to the weight. As stated, the scale 13 is configured to transmit weight data to the unique identification tag 30, and the unique identification tag 30 is configured to upload the weight data upon connecting to a network. A display in the scale area may also display the weight. Optionally, the weight data can also be transmitted to the unique identification tag 30 for storage, to serve as a redundant backup, which may be desired if the base station 15 is not present or is offline.

The weight data can be transmitted from the base station 15 to the service provider 19. The service provider 19 maintains a database 31 of records pertaining to each animal 29. The service provider 19 associates a logical record with the unique identification tag 30 and stores any information relayed from the base station 15 or the unique identification tag 30 in the record.

The service provider 19 maintains logic that is configured to determine periodic data pertaining to the animal 29, such as vaccination schedules, estrus cycles, or other maintenance metrics related to the animal 29. Other examples include but are not limited to health evaluations, medicine administration, artificial insemination, and/or removal of the animal from a pasture for various reasons. Thus, when the animal 29 is being weighed, the service provider 19 can determine if the animal 29 is in need of attention.

If attention is required, for any reason, the service provider 19 can identify what attention is needed and transmit instructions to a mobile device 32 (any mobile device) of a rancher or ranch hand. The gates can be automatically locked by the service provider 19 to trap the animal 29 for attention based on the information associated with the animal 29 in the database 31. For example, the database 31 has a record for the animal 29 that indicates that the animal 29 is due for vaccinations.

The rancher can deliver a corresponding service or perform an action. For example, the rancher could administer a medicament, the rancher could remove the animal 29 for insemination, or the animal 29 could be removed and taken away for various reasons such as surgery, livestock rotation, slaughter, and so forth. If the rancher is unable to deliver a corresponding service or perform an action on the animal in a timely manner (could be user adjustable time period or automatically calculated) from when the animal is captured between the gates, the rancher can select to release the animal and open the gates using, for example, a mobile device, or the gates may be opened automatically after a set period of time. For example, the base station could automatically activate a gate to release the animal.

In some instances, the animal 29 may receive attention if the camera footage is reviewed and it is determined that the animal 29 appears to be unhealthy or injured. For example, an animal 29 may appear emaciated or may have a gait that is indicative of an injury. In some instances, the base station 15 can receive a signal from the service provider (or the base station 15 can independently cause) an auto-injector 66 to inject the animal with medicine.

Once evaluation is complete and any necessary attention has been rendered to the animal 29 while it is between the first gate 12 and the second gate 14, the second gate 14 can be opened to allow the animal 29 to enter the enclosure 16. Thus, the service provider 19 is configured to cause an automatic action to be taken by one or more gates to trap the animal in an enclosure upon detection of the unique identification tag 30 by the identification reader 33. In some instances, the service provider 19 or base station 15 can be configured to determine an optimal time to close the gates of the temporary confinement area 11 to lock the animal 29 into position to prevent injury to the animal 29. In some instances, the temporary confinement area 11 can include a headlock apparatus that is actuated to secure around the neck or head of the animal 29 to keep the animal 29 stationary. This type of confinement may be desired when the action is likely to startle or frighten the animal 29.

The base station 15 can also include a directional antenna 35 to detect and communicate with the unique identification tag 30. In some embodiments, the directional antenna 35 is mounted above where a head of an animal is supposed to be in the temporary confinement area 11, such that the directional antenna 35 can communicate with the unique identification tag 30 of the animal 29 in the temporary confinement area 11.

Again, the enclosure 16 is a gated or fenced perimeter that is configured to hold the animal 29. In some instances, an attractant 18 is used to lure the animal 29 into the temporary confinement area 11 and finally into the enclosure 16. The attractant 18 could include, but is not limited to, any one or more of water, feed, mineral, and the like.

In one embodiment, the system 10 includes an automatic chemical applicator 64 for applying a chemical to the animal 29 based on the information associated with the animal 29 in the database 31. The automatic chemical applicator 64 could be placed in the enclosure 16 or in the temporary confinement area 11 area. Again, the chemical applicator 64 could apply a medicament (boosters, vaccines, and other medical treatments), a disinfectant, and/or any other desired chemical.

After the rancher has kept the animal 29 in the enclosure 16 and has given the animal 29 any needed attention, the third gate 17 can be manually or automatically opened to allow the animal 29 to enter a paddock or other area. The animal 29 can be removed via a trailer or other implement through the third gate 17. Also, the temporary confinement area 11 could be configured to receive animals from a trailer. Regardless, the third gate 17 or temporary confinement area 11 can be adapted to or be configured with a loading ramp, a portable chute, or the like.

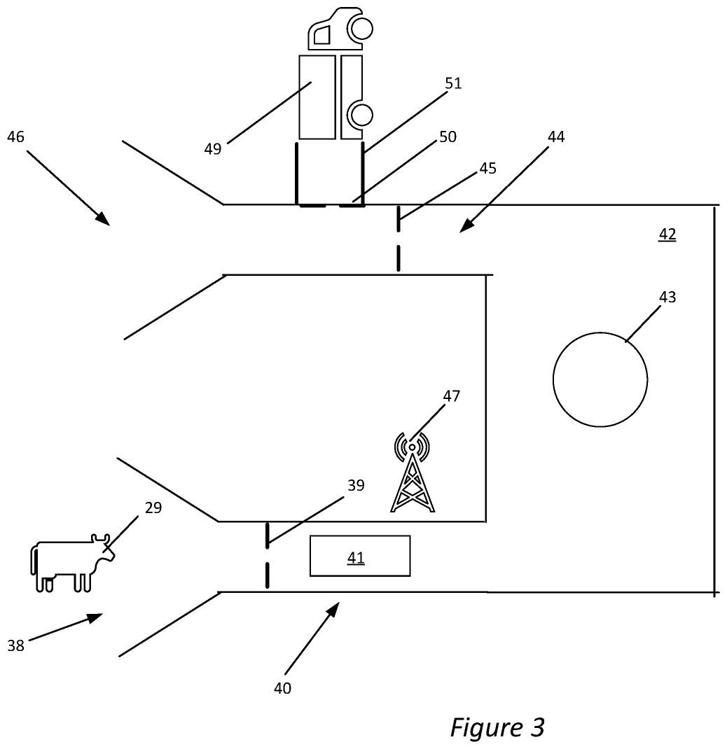

FIG. 3 is another example configuration of a system 37 for livestock weighing and isolation. The configuration includes an entrance 38, a one-way gate 39, a temporary confinement area 40, a scale 41, an enclosure area 42, an attractant 43, an exit pathway 44, an exit gate 45, an exit opening 46, and a base station 47.

An animal 29 can be funneled into the entrance 38 and through the one-way gate so that the animal 29 can be weighed on the scale 41. The components of the system are functionally equivalent to the system disclosed above with respect to system 10. Structural differences in the system 37 compared to system 10 include the overall shape, the omission of a gate immediately after the scale 41. The enclosure area 42 is open to the scale 41 and the exit opening 46. In some instances, the exit gate 45 can be actuated manually or automatically to allow the animal 29 to be loaded onto a truck or trailer. That is, the exit gate 45 is adapted to interface with an extraction means 49 such as a portable chute, loading ramp, or truck. In some embodiments, the system 37 can include another exit gate 50 that is positioned before the exit gate 45. Also, a fenced or railed area can be created between the exit gate 45 and the extraction means 49, referred to as an isolation area 51.

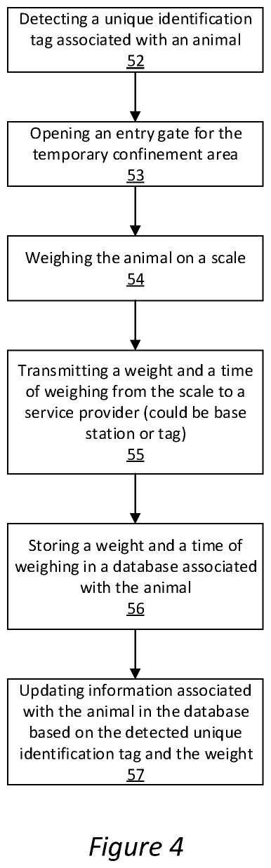

FIG. 4 is a flowchart of an example method. The method can be initiated when livestock are directed towards the temporary confinement area of an enclosure. In one embodiment, the method includes a step 52 of detecting a unique identification tag associated with an animal. For example, the tag can emit a beacon signal that is received by the base station. The animal is identified by the unique ID of the tag and information pertaining to the animal is accessed from a database.

When the animal is detected, the method can include a step 53 of opening an entry gate for the temporary confinement area. In one embodiment, this can be done manually, but in some instances, the gate can be automatically opened when a base station determines that the animal is present. Once inside the temporary confinement area, the gate can be closed to trap the animal in an enclosure for attention based on the information associated with the animal in the database. In some instances, this process can include determining an optimal time to close a chute to lock the animal into position to prevent injury to the animal. This could be determined from the walking speed of the animal, which can be determined from the signals emitted from the tag. Since these signals can be emitted frequently, the time between signals can be used to infer distance. This distance change over time is the walking speed, and the gate can be timed to close based on this walking speed.

Upon entering the temporary confinement area, the animal will encounter the scale. Next, the method includes a step 54 of weighing the animal on a scale, as well as a step of transmitting a weight and a time of weighing from the scale to a service provider (could be a base station or tag). In some instances, this transmission is direct, while in other instances it is indirect where these data are transmitted to a base station, which relays the data to a service provider. Once received, the method includes a step 56 of storing a weight and a time of weighing in a database associated with the animal. Again, this can include temporarily storing the data in the tag of the animal. Once the weight has been determined, the method can include a step 57 of updating information associated with the animal in the database based on the detected unique identification tag and the weight.

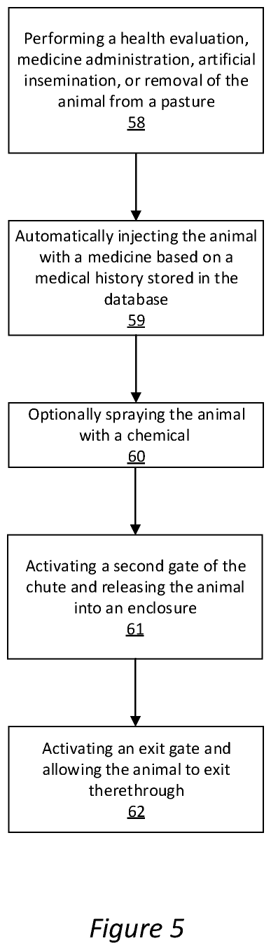

FIG. 5 is a related method that can be performed in series with the method of FIG. 4. Again, the animal has been trapped in the chute/enclosure for attention. In some instances, attention is weighing the animal and taking pictures of the animal. Cameras and/or other optical scanners can be mounted all four corners (or fewer) of the temporary confinement area to obtain images of the body of the animal in a 360-degree view. In this way, images can be obtained in large pasture settings when animals enter an isolation system of the present disclosure.

When the animal is in the chute and has been detected by the system, the information stored about that animal is accessed where it may be determined that additional attention is necessary. For example, the method can include a step 58 of performing a health evaluation, medicine administration, artificial insemination, or removal of the animal from a pasture. In a related step, the method can include a step 59 of automatically injecting the animal with a medicine based on a medical history stored in the database. The injection could include boosters, vaccines, and other medical treatments.

In some instances, the method can include spraying the animal with a chemical in step 60. This can occur inside the chute or in the larger enclosure. In some embodiments, the method includes extracting the animal from the enclosure through a loading ramp or trailer that is configured to dock or mate with yet another gate of the enclosure. The method could include a step 61 of activating a second gate of the chute and releasing the animal into an enclosure. The enclosure could include food, water, and/or a mineral. In instances where the animal can return to the area where it entered the chute, the method can include a step 62 of activating an exit gate and allowing the animal to exit therethrough. Additionally, this pasture isolation system in whole may optionally be designed so that it can easily be disassembled and reassembled in another area (next pasture/paddock) and is transportable.

Any and all headings are for convenience only and have no limiting effect. Unless otherwise defined, all technical and scientific terms used herein have the same meaning as commonly understood by one of ordinary skill in the art to which this invention belongs. Although specific terms are employed herein, they are used in a generic and descriptive sense only and not for purposes of limitation. All patent applications, patents, and printed publications cited herein are incorporated herein by reference in their entireties, except for any definitions, subject matter disclaimers or disavowals, and except to the extent that the incorporated material is inconsistent with the express disclosure herein, in which case the language in this disclosure controls.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a telecommunications network, such as the Internet.

It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention. These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, the computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

The present invention may be embodied in other specific forms without departing from the spirit or essential attributes thereof, and it is therefore desired that the present embodiment be considered in all respects as illustrative and not restrictive. Many modifications and other embodiments of the present disclosure will come to mind to one skilled in the art to which this invention pertains and having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although methods and materials similar to or equivalent to those described herein can be used in the practice or testing of the embodiments in the present disclosure, suitable methods and materials are described above. Thus, the present disclosure is not intended to be limited to the embodiments shown, but is to be accorded the widest scope consistent with the principles and features disclosed herein.

While various embodiments have been described above, it should be understood that they have been presented by way of example only, and not limitation. The descriptions are not intended to limit the scope of the technology to the particular forms set forth herein. To the contrary, the present descriptions are intended to cover such alternatives, modifications, and equivalents as may be included within the spirit and scope of the technology as defined by the appended claims and otherwise appreciated by one of ordinary skill in the art. The various embodiments of the present disclosure may be embodied in other specific forms without departing from the spirit or essential attributes thereof, and it is therefore desired that the various embodiments in the present disclosure be considered in all respects as illustrative and not restrictive. Thus, the breadth and scope of a preferred embodiment should not be limited by any of the above-described exemplary embodiments.

Unless otherwise defined, all technical and scientific terms used herein have the same meaning as commonly understood by one of ordinary skill in the art to which this invention belongs. All patent applications, patents, and printed publications cited herein are incorporated herein by reference in their entireties, except for any definitions, subject matter disclaimers or disavowals, and except to the extent that the incorporated material is inconsistent with the express disclosure herein, in which case the language in this disclosure controls. Any headings utilized within the description are for convenience only and have no legal or limiting effect.

What is claimed is:

1. A system for monitoring and managing livestock, the system comprising:
an enclosure;
a temporary confinement area associated with the enclosure, the temporary confinement area having at least one gate that can be actuated to open and allow an animal to enter and to close and confine the animal in the temporary confinement area;
a scale for weighing the animal in the temporary confinement area;
an identification reader for detecting a unique identification tag associated with the animal;
a database for storing information associated with the animal, including a weight of the animal and time of weighing; and
a service provider configured to update the information associated with the animal in the database upon receiving the weight from the scale and detecting the unique identification tag by the identification reader.

2. The system of claim 1, further comprising an attractant inside the enclosure to lure the animal onto the scale, wherein the attractant is at least one of feed, water, and/or mineral.

3. The system of claim 1, further comprising a base station that is configured to automatically open a gate based on the detection of the unique identification tag by the identification reader, and automatically close the gate when the animal steps onto the scale.

4. The system of claim 3, wherein the service provider is configured to determine that the animal requires attention based on the information stored in the database, wherein attention includes a health evaluation, medicine administration, artificial insemination, and/or removal of the animal from a pasture.

5. The system of claim 1, wherein the scale is configured to transmit the weight to the unique identification tag, and the unique identification tag is configured to upload the weight upon connecting to a network.

6. The system of claim 1, wherein the service provider is further configured to cause an automatic action to be taken by the at least one gate to trap the animal in the enclosure.

7. The system of claim 1, further comprising an automatic chemical applicator for applying a chemical to the animal based on the information associated with the animal in the database.

8. The system of claim 1, further comprising a directional antenna connected into a base station to record data associated to the unique identification tag detected by the directional antenna.

9. The system of claim 8, wherein the directional antenna is mounted above where a head of an animal is positioned in a temporary confinement area, such that the directional antenna communicates with the unique identification tag of the animal in the temporary confinement area.

10. A method for automatically managing livestock, the method comprising:
detecting a unique identification tag associated with an animal;
opening at least one gate of a temporary confinement area associated with an enclosure to allow an animal to enter;
closing the at least one gate to confine the animal in the temporary confinement area;
weighing the animal on a scale; and
updating a database that stores information associated with the animal, including a weight of the animal and time of weighing obtained from the scale.

11. The method of claim 10, further comprising luring the animal onto the scale using an attractant, which is at least one of feed, water, and/or mineral.

12. The method of claim 10, further comprising trapping the animal in an enclosure for attention, based on the information associated with the animal.

13. The method of claim 12, wherein the attention includes a health evaluation, medicine administration, artificial insemination, or removal of the animal from a pasture.

14. The method of claim 10, further comprising transmitting the weight from the scale to the unique identification tag, and uploading the weight from the unique identification tag when in communication with a network.

15. The method of claim 10, further comprising causing an automatic action to be taken by a gate to trap the animal upon detection of the unique identification tag.

16. The method of claim 10, further comprising automatically applying a chemical to the animal based on the information associated with the animal in the database.

17. The method of claim 10, further comprising determining an optimal time to close a temporary confinement area to lock the animal into position to prevent injury to the animal.

18. The method of claim 17, further comprising injecting the animal with a medicine based on a medical history stored in the database, upon detecting the animal in a temporary confinement area by a base station.

19. The method of claim 18, wherein the medicine is any of boosters, vaccines, and other medical treatments.
